(19) United States
(12) Patent Application Publication
(10) Pub. No.: US 2007/0261055 A1
(43) Pub. Date: Nov. 8, 2007

(54) Method and system for the generic and flexible access of available tasks through a user interface

(75) Inventors: Anugeetha Kunjithapatham, Sunnyvale, CA (US); Mithun Sheshagiri, Berkeley, CA (US); Alan Messer, Los Gatos, CA (US)

Correspondence Address: Kenneth L. Sherman, Esq.;Myers Dawes Andras & Sherman, LLP, 11th Floor, 19900 Mac Arthur Blvd., Irvine, CA, 92612, US

(73) Assignee: Samsung Electronics Co., Ltd., Suwon City (KR)

(21) Appl. No.: 11/429,375

(22) Filed: May 4, 2006

(51) Int. Cl. G06F 9/46

(52) U.S. Cl. 718/100

(57) ABSTRACT

A task access system implements a methodology that facilitates one to explore and execute tasks possible in a network such as a home network environment. The system provides interfaces to access task information and supports several types of functionalities that help in customization of the task information based on the requesting user's state/context. The system supports composing a task request in different ways. It allows a task request to be composed and executed in an incremental fashion or at one-go, thus enabling user interface applications to be flexible. When a user requests to know the tasks available in the network, the system applies security policies and more user context information to customize and prioritize the tasks available for each user and ensures that the user interface application does not display tasks that are not executable by the user. Further, the system dynamically updates the user interface application based on the user input and any changes in the network environment, such as addition or removal of devices/services, thus ensuring only meaningful information is displayed to the user. In addition, the user is updated with the newly possible tasks and the ones no longer available. By dynamically updating the choices available for the user, the system effectively guides the user input.

### FIELD OF THE INVENTION

The present invention relates to providing user interfaces for user control of devices, and in particular to providing generic and flexible access of available tasks through a user interface.

### BACKGROUND OF THE INVENTION

With the proliferation of networks such as home networks, there has been a need to provide a system and methodology that facilitates exploring and executing tasks possible in a home network including multiple devices.

One conventional approach provides a system that discovers devices and thereby the services available in an ad-hoc environment, identifies the services that could be aggregated and finally suggests the possible service combinations to the user. While suggesting the aggregated service combinations to the user, the system scores the services based on any user preferences set and execution history for the user and displays the service with the highest score to the user. However, such an approach does not allow the user to incrementally compose a task request and rather just suggests a list of service combinations possible to the user. This results in a non-flexible design for user interface applications.

Another conventional approach provides a system that discovers services/devices in an office scenario and composes tasks using these services. It further provides a means for executing these tasks. It automatically composes tasks that involve two services and provides a manual way of composing tasks with more than two services. However, a disadvantage of such a system is that it does not take into consideration security policies and other user context such as location of user and the device used to customize the services available in the home. This could result in the user interface application displaying services that are not executable by the user.

The Windows and Apple Mac operating systems support user interface menus that suggest “tasks” when the user right-clicks on files and directories on a PC/Mac; they also have wizards which guide the user to accomplishing tasks. However, in such systems, simplistic menu based operations are utilized to achieve this and hence they are not dynamic or flexible.

### BRIEF SUMMARY OF THE INVENTION

An object of the present invention is to provide a system implementing a methodology that facilitates one to explore and execute tasks possible in a network such as a home network environment. In one embodiment, such a system provides interfaces to access task information and supports several types of functionalities that help in customization of the task information based on the requesting user's state/context. Tasks are the activities that can be performed in the network represented by pseudo sentences (e.g., Play, movie, in the Living Room TV, etc.)

In one embodiment, such a system supports composing a task request in different ways. It allows a task request to be composed and executed in an incremental fashion or at one-go, thus enabling user interface applications to be flexible.

When a user requests to know the tasks available in the network (through a User Interface application), the system applies security policies and more user context information, such as the location of user and the device used by the user, to customize and prioritize the tasks available for each user and ensures that the user interface application does not display tasks that are not executable by the user.

Further, the system dynamically updates the user interface application based on the user input and any changes in the network environment, such as addition or removal of devices/services, thus ensuring only meaningful information is displayed to the user. Further, the user is updated with the newly possible tasks and the ones no longer available. Moreover, by dynamically updating the choices available for the user, the system effectively guides the user input.

These and other features, aspects and advantages of the present invention will become understood with reference to the following description, appended claims and accompanying figures.

### BRIEF DESCRIPTION OF THE DRAWINGS

FIG. 1 shows an example of a functional block diagram of a network implementing a task access method according to an embodiment of the present invention.

FIG. 2 shows a flowchart of steps in an example access method including a sequence of interactions between the UIA and UTM components in the network of FIG. 1, according to an embodiment of the present invention.

FIG. 3 shows a flowchart of steps in another example access method including a sequence of interactions between the UIA and UTM components in the network of FIG. 1, according to an embodiment of the present invention.

FIG. 4 shows an example of a network implementing an embodiment of the present invention.

### DETAILED DESCRIPTION OF THE INVENTION

In one embodiment the present invention provides a system implementing a methodology that facilitates one to explore and execute tasks possible in a network, such as a home network environment. The system provides interfaces to access task information and supports several types of functionalities that help in customization of the task information based on the requesting user's state/context. Tasks are the activities that can be performed in the network, wherein tasks can be represented by pseudo sentences (e.g., Play, movie, in the Living Room TV, etc.). Examples of tasks and task generation are provided in commonly assigned patent applications U.S. Ser. No. 10/947,774 for “Method and system for presenting user tasks for the control of electronic devices,” filed on Sep. 22, 2004, U.S. Ser. No. 10/950,121 for “Method and system for describing consumer electronics using separate task and device descriptions,” filed on Sep. 24, 2004, U.S. Ser. No. 10/948,399 for “A method and system for the orchestration of tasks on consumer electronics,” filed on Sep. 22, 2004, U.S. Ser. No. 11/200,546 for “Contextual task recommendation: A method for determining the user's context and suggesting tasks,” filed on Aug. 9, 2005 and U.S. Ser. No. 11/200,547 for “Method and system for prioritizing tasks made available by devices in a network,” filed on Aug. 9, 2005 (all incorporated herein by reference).

An access system according to the present invention supports composing a task request in different ways. It allows a task request to be composed and executed in an incremental fashion or at one-go, thus enabling user interface applications to be flexible. One-go means that the present invention provides interfaces to a User Interface Application (UIA) that would enable users to choose and execute a task (for e.g.: ‘Play Movie’) with just one-click. Two example ways of accessing tasks in a home include: (1) providing the various fields in the available task ‘pseudo-sentences’ (e.g., verb, subject, etc.) separately, thus allowing the user to access and choose these fields incrementally (doing this requires more than one-click); or (2) providing the entire task pseudo-sentences' (e.g., “Play Movie”) and allowing the user to execute this by just pressing ‘ok’. This second way is referred to a as ‘executing tasks at one-go’.

When a user requests to know the tasks available in the network (e.g., through a User Interface application), the system applies criteria such as security policies and more user context information (e.g., location of the user in the home, the device used, etc.), to customize and prioritize the tasks available for each user and ensures that the user interface application does not display tasks that are not executable by the user. The system dynamically updates the user interface application based on the user input and any changes in the network environment, such as addition or removal of devices/services, thus ensuring only meaningful information is displayed to the user. Further, the user is updated with the newly possible tasks and the ones no longer available. Moreover, by dynamically updating the choices available for the user, the system effectively guides the user input.

In the following, an example of an access system implementing an access method according to the present invention is described.

An access system implementing an access method according to an example of the present invention supports several interfaces and functionalities for use by potential user interface applications. As such, the system provides a way to explore and execute tasks possible in a network (e.g., home network). Though in this description the present invention is described as implemented in a home network, those skilled in the art will recognize that the present invention is applicable to other networks. As such, the present invention is not limited to home networks.

Generally, an access system according to the present invention provides task-related choices to the user/application and also dynamically updates the choices available based on the user's input so far, and the state (status) of the devices in the home network at that instance, thereby effectively guiding the user input.

The main design principles of the example system include efficient techniques to browse through the tasks possible in a home network and intelligent control of the devices in the network. Major functionalities provided by the example system include:
Providing interfaces to explore task(s) possible in a home network (i.e., interfaces provide task-related choices available for the user to compose a task request from). In other words, the system provides interfaces to explore task(s) possible in a home network (i.e., interfaces provide task-related choices that the user could use to compose task request(s)).
Proactively updating/filtering the task related choices provided to the user, based on the user's input and the state of the devices in the network, as when the user is framing his task request.
Providing interfaces to execute a task in a home network environment.
Utilizing appropriate functionalities provided by an underlying middleware to appropriately access and control the devices needed to execute a task.
Providing interfaces to store/pass on choices made by the user and other information including the user-context such as the location of the user and the device used by the user. In one example, User Location is basically the room (in the home) where the user is currently located. It is inferred from the location of the device he is currently using, which in turn is inferred from user actions such as a user inserting a CD/DVD or accessing the UIA on a particular device, etc. Examples of locations include ‘Living Room’, ‘Bedroom’, etc. The device used by the user can be any of the devices in the home network, such as DTV, PC, etc.
Customizing and prioritizing task related information based on the requesting user's state/context such as the location of the user, device used as the client, security policies applicable to the user, prior choices made by the user, prior tasks executed by the user, etc. The location of the client device (i.e., the device executing the UIA), is used to infer the location of the user.
Dynamically updating the user interface application (and the user) about the newly possible tasks and tasks no longer available, based on the current state of devices in the home and the user's context.

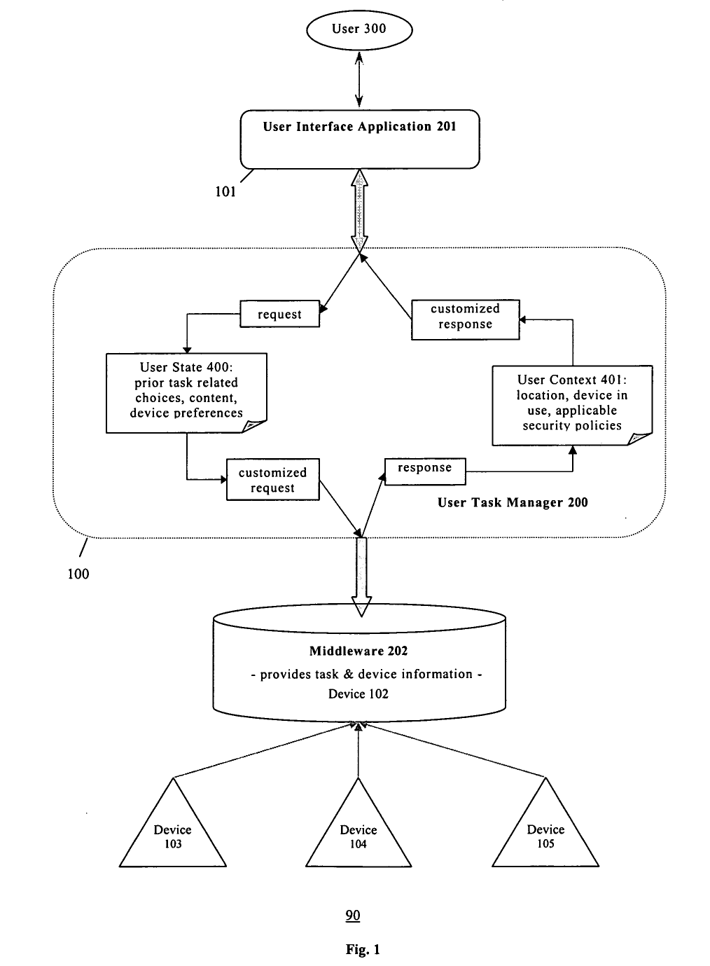

Referring to the example network 90 in FIG. 1, in one implementation of an access method and system in the network 90 according to the present invention, a User Task Manager (UTM) 200 provides interfaces for user interface applications to access and execute tasks available in the home network 90 utilizing devices (e.g., devices 103, 104, 105, etc.) in the network 90. In one example, a task is represented as a combination of a verb, subject, devices and attributes. A User Interface is the interface between a user and a computer program, which is supported by the User Interface Application (UIA) 201. The UTM 200 provides functionality and interface to support that UIA 201.

The UTM 200 also provides several functionalities that assist in customizing the task information based on the user's context (most of these functionalities are not visible to the user and the UIA at the interfaces level). The UIA 201 and the UTM 200 may reside on the same or different devices in the network 90. In the example shown in FIG. 1, the UIA 201 resides on a device 101 and the UTM 200 resides on device 101. In operation, a user 300 starts the UIA 201 for interaction with network 90.

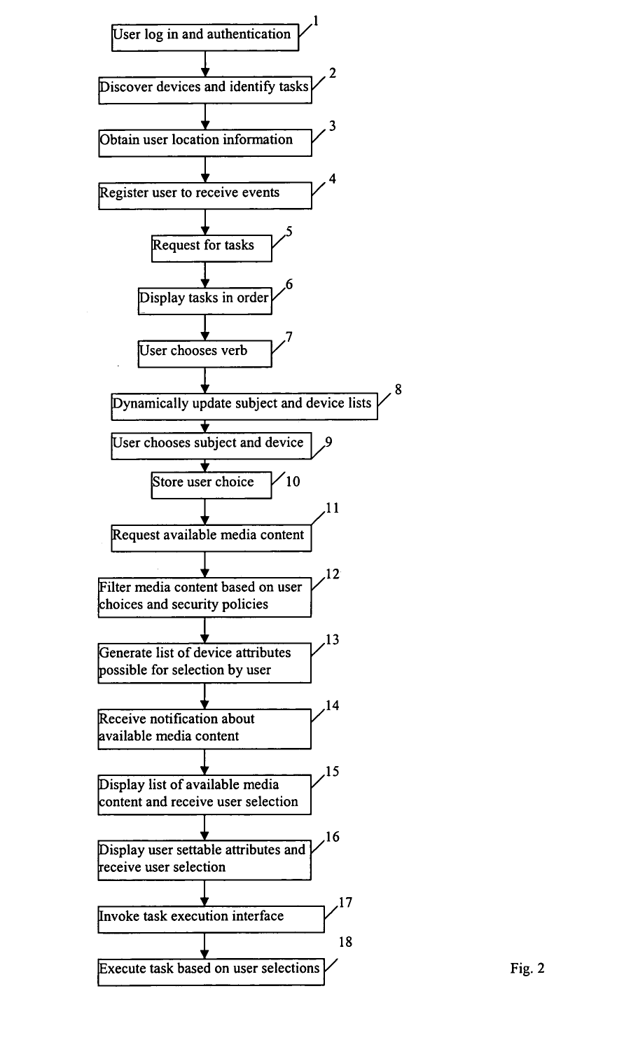

Referring to the flowchart in FIG. 2 in conjunction with network 90 in FIG. 1, an example sequence of interactions between the UIA 201 and UTM 200 in implementing an access method according to the present invention includes steps 1-18, wherein:
1. The UIA 201 prompts the user 300 to login. The UIA 201 checks with UTM 200 if the user 300 is authenticated (e.g., the UTM 200 uses the underlying middleware 202 components on device 102 to authenticate the user 300).
2. The underlying middleware 202 discovers the devices e.g. 102, 103, 104, 105, etc., on the home network and identifies the tasks that could be executed using the discovered devices.
3. The UIA 201 obtains the location information for the user 300 and passes it on along with the user 300 login information to the UTM 200.
4. The UIA 201 registers the user 300 with the UTM 200 to receive events about the availability of new tasks and the unavailability of task(s).
5. The UIA 201 requests UTM 200 for tasks available in the home; UTM 200 obtains the task combination list computed by the underlying middleware 202 and scores/filters the task combinations based on the user context 401 (e.g., location and device of the user 300) and returns the list of prioritized task combinations to the UIA 201.

6. The UIA 201 displays to the user 300 the various tasks possible (e.g., displays only the verb, subject and devices at this stage), in an order based on the scores assigned to the tasks. In this example implementation, a ‘score’ field (e.g., a numeric value) is associated with each task. A task inferred to be of more interest to the user gets a higher ‘score’ value.

7. The user 300 chooses a verb and the UIA 201 passes-on the choice (e.g., “Play”, etc.) to the UTM 200

8. The subject list and device list on the UIA 201 is dynamically updated by UTM 200. UTM 200 identifies the subjects and devices relevant to the user 300 based on the current verb choice and notifies the UIA 201 about the same.
9. Then the user 300 chooses a subject and the device(s); UIA 201 passes-on these choices to UTM 200.
10. UTM 200 stores the user choices in a user state 400 object, reserved for that particular session started by the user 300.
11. UIA 201 requests UTM 200 for media content available in the home.
12. UTM 200 gets hold of the media content available in the home through the underlying middleware 202 and filters it based on the user state 400 (e.g., the choices made by the user 300) and applicable security policies (obtained from the underlying middleware 202).
13. UTM 200 further returns a list of device attributes that are possible to be set by the user 300 that it identifies by filtering the set of attributes possible to be set based on the user's state 400 and/or context 401.
14. UTM 200 notifies UIA 201 about the media content available for the user 300, through events.
15. The UIA 201 displays the list of media content available to the user 300; the user 300 chooses media content and the UIA 201 passes-on the choice to UTM 200.
16. The UIA 201 displays the attributes that can be set by the user 300; the user 300 chooses some of them and the choices are passed-on to UTM 200.
17. Further UIA 201 invokes the UTM 200 interface that executes the task.
18. UTM 200 uses the underlying middleware 202 to execute the tasks using devices in the network.

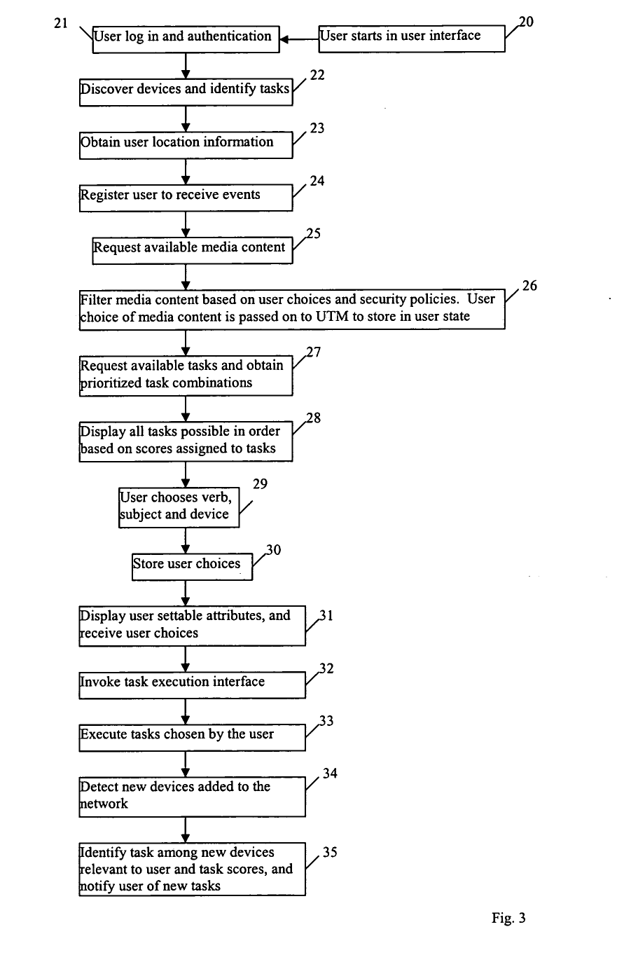

Referring to the flowchart in FIG. 3 in conjunction with network 90 in FIG. 1, another example sequence of interactions between the UIA 201 and UTM 200 in implementing another access method according to the present invention includes steps 20-35, wherein:
20. A user 300 starts the UIA 201
21. The UIA 201 prompts the user 300 to login. The UIA 201 checks with UTM 200 if the user 300 is authenticated (UTM 200 uses the underlying middleware 202 components to authenticate the user 300).
22. The underlying middleware 202 on device 102 discovers the devices e.g. 102, 103, 104 and 105 in the home, and identifies the tasks that could be executed using the discovered devices.
23. The UIA 201 obtains the location information for the user 300 and passes it on, along with the user 300's login information, to UTM 200.
24. The UIA 201 registers the user 300 with UTM 200 to receive events about the availability of new tasks and the unavailability of task(s).
25. UIA 201 requests UTM 200 for media content available in the home network.
26. UTM 200 obtains the media content available in the home network through the underlying middleware 202 and filters it based on applicable security policies (obtained from the underlying middleware 202). Further, the user chooses a media content and the choice is passed on to UTM 200. Then, UTM 200 stores the choice in its user state.
27. The UIA 201 requests UTM 200 for tasks available in the home; UTM 200 obtains the task combination list computed by the underlying middleware 202 and scores/filters them based on the user's context 401 (location and device of the user 300) and the choices made (the chosen media content in this case) and returns the list of prioritized task combinations to the UIA 201.
28. The UIA 201 displays to the user 300 all the tasks (displaying the verb, subject and devices at this stage) possible in an order based on the scores (priority) assigned to the tasks.
29. The user 300 chooses a verb, subject and device; UIA 201 passes-on the user 300 choices to UTM 200.
30. UTM 200 stores the user 300's choices in a user state 400 object, reserved for that particular session started by the user 300.
31. The UIA 201 displays the various attributes that could be set by the user 300; the user 300 chooses some of them and the choices are passed-on to UTM 200.
32. Further UIA 201 invokes the UTM 200 interface that executes the task.
33. UTM 200 uses the underlying middleware 202 to execute the task.
34. A new device is added in the home and consequently UTM 200 identifies the new tasks achievable in the home.
35. UTM 200 identifies the tasks among the new devices that are relevant to the user 300 and scores them based on the user context 401 (e.g., location and device of the user 300) and dispatches events to the UIA 201 notifying the user 300 about those tasks.

In step 5 above, examples of task combinations returned by the middleware 202 to UTM 200 include: “Play Music LivingRoom-HiFi Stereo”, “Play Movie LivingRoom-HDTV”, “Play Movie Bedroom-PlasmaTV”, “Show Photos LivingRoom-HDTV, etc. Further, examples of PRIORITIZED task combinations returned by UTM 200 to UIA 201 include: “Play Movie LivingRoom-HDTV”, score—100; “Show Photos LivingRoom-HDTV”, score—80; “Play Music LivingRoom-HiFi Stereo”, score—60; “Play Movie Bedroom-PlasmaTV”, score—40; etc.

As noted in step 8 above, the UTM 200 identifies the subjects and devices relevant to the user 300 based on the current verb choic and notifies the UIA 201 about the same. In one example, if the following are the tasks available in the home: “Play Music LivingRoom-HiFi Stereo”, “Play Movie LivingRoom-HDTV”, “Play Movie Bedroom-PlasmaTV”, “Show Photos LivingRoom-HDTV”, etc., then if the current verb choice is ‘Play’, the UTM 200 returns the following subjects—‘Movie’, ‘Music’ and devices such as ‘LivingRoom-HDTV’, ‘BedRoom-PlasmaTV’, etc.

In step 12 above, if the user has chosen ‘Movie’ as the subject, then the UTM 200 accessed the list of all available media content (e.g., Movie, Music and Image content, etc.) from the underlying middleware 202 and filters out the Movie content from this list and sends only the Movie content to the UIA 201 (through events as specified in step 14).

In step 13 above, if the user has selected options e.g. verb—‘Play’, subject—‘Movie’, device—‘LivingRoom-HDTV’ and content-DVD movie ‘The Matrix’, then the UTM 200 performs the following types of filtering:
i) Since the HDTV in the LivingRoom supports WideScreen format and the content chosen by the user (The Matrix) also supports this, the UTM 200 sends this attribute to the UIA 201.
ii) Since the HDTV does not support Surround-Sound format and although the DVD content chosen supports this, the UTM 200 filters out this attribute and does not pass it on to the UIA 201. (Note: these attributes are displayed to the user 300 in step 16.)

In step 27 above, example user tasks available in the home can include: “Play Music LivingRoom-HiFi Stereo”, “Play Movie LivingRoom-HDTV”, “Play Movie Bedroom-PlasmaTV”, “Show Photos LivingRoom-HDTV”, “Print Photos LivingRoom-Printer”, “Show Photos Bedroom-PlasmaTV”, etc. If the user chooses a Picture ‘Hawaii-trip1’ in the previous step (26) and the location of the user is ‘LivingRoom’, then, in step 27, the UTM 200 returns the following tasks to the user (in this order): “Show Photos LivingRoom-HDTV”, score—100; “Print Photos LivingRoom-Printer”, score—80; “Show Photos Bedroom-PlasmaTV”, score—10.

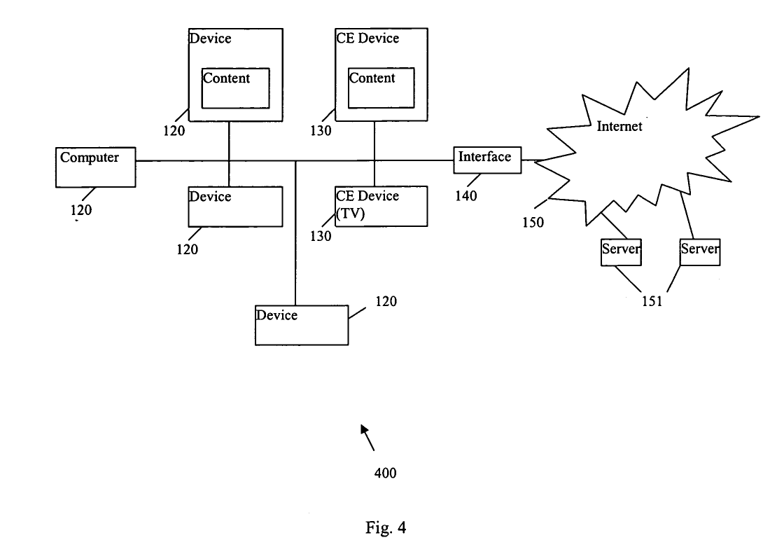

FIG. 4 shows a functional architecture of an example network 400, such as a local network (e.g., home network), embodying aspects of the present invention. As such, the network 400 embodies a system for the generic and flexible access of available tasks through a user interface, according to an embodiment of the present invention. The network 400 comprises devices 120 (e.g., TV, VCR, PC, STB, etc.) which may include content, CE devices 130 (e.g., TV, cell phone, PDA, etc.) which may include content, and interface 140 that connects the network 400 to an external network 150 (e.g., another local network, the Internet, etc.). The external network can be connected to one or more servers 151. Though the devices 120 and 130 are shown separate, a single physical device can include one or more logical devices. The devices 120 and 130, respectively, can implement protocols such as HTTP, UPnP, Jini, HAVi, 1394, etc., for communication therebetween. Though in the example described herein the HTTP protocol is utilized by the network 400, as noted, those skilled in the art will recognize that the present invention is useful with other network communication protocols.

Preferably, the UIA 201 is implemented on a device with a display system. The UTM 200 and other functional modules (including module 202) can be implemented on any device with memory capabilities (e.g., device 20 or 30). For example, the UTM 200 and the underlying middleware can be implemented on a Digital Television set, and the UIA 201 can also be implemented on that Digital Television set. In other examples, the UTM 200 and the UIA can be implemented on different devices.

As such, an access method/system according to the present invention facilitates exploration and execution of tasks in a network, utilizing an interface to access task information by supporting multiple functionalities for customizing the task information based on user state/context. The access system allows composing a task request in different ways, wherein a task request can be composed and executed as desired. Upon user request, the system applies security policies and more user context information to customize and prioritize the tasks available for each user and ensures that a user interface application does not display tasks that are not executable by the user. The system dynamically updates the user interface application based on the user input and any changes in the network environment to ensure display of meaningful information to the user. The user is updated with any newly possible tasks and the ones no longer available. By dynamically updating the choices available for the user, the system effectively guides the user input.

The present invention has been described in considerable detail with reference to certain preferred versions thereof; however, other versions are possible. Therefore, the spirit and scope of the appended claims should not be limited to the description of the preferred versions contained herein.

What is claimed is:

1. A method of exploring tasks and executing tasks on one or more of a plurality of electronic devices in a network, comprising the steps of:
determining a user's context in the network;
generating list of available tasks based at least on the user context;
providing task choices to the user;
receiving user input; and
dynamically updating the choices available to the user based on the user's input and the state of the devices, thereby effectively guiding the user input.

2. The method of claim 1 further including the steps of determining state of the devices in the home network.

3. The method of claim 1 wherein the step of dynamically updating further includes the steps of:
while the user provides input, dynamically updating the choices available to the user based on the user's input and the state of the devices, thereby effectively guiding the user input.

4. The method of claim 1 further including the steps of allowing a user to browse through the tasks possible in the network.

5. The method of claim 1 further including the steps of providing intelligent control of the devices in the network based on the user context and device state in the network.

6. The method of claim 1 further including the steps of providing interfaces for exploring tasks possible in the network.

7. The method of claim 1 further comprising the steps of providing task-related choices available for the user to compose a task request.

8. The method of claim 7 further including the steps of updating and filtering the task related choices provided to the user, based on user input and the state of the devices in the home.

9. The method of claim 8 further including the steps of updating and filtering the task related choices provided to the user, based on user input and the state of the devices in the home, as the user is framing a task request.

10. The method of claim 1 further including the steps of providing interfaces to execute a task by the devices in the network.

11. The method of claim 10 further including the steps of providing middleware functionalities to appropriately access and control the devices needed to execute a task.

12. The method of claim 11 further including the steps of providing interfaces to store and communicate to the middleware layer information including user choices, user context and a device used by the user.

13. The method of claim 1 further including the steps of customizing and prioritizing task related information based on the user context and device states.

14. The method of claim 13 wherein the steps of customizing and prioritizing further include the steps of customizing and prioritizing task related information based on one or more of: user location, device used as a client, security policies applicable to the user, prior choices made by the user and prior tasks executed by the user.

15. The method of claim 1 wherein the step of dynamically updating further includes the steps of dynamically updating a user interface application to notify the user of newly possible tasks and tasks no longer available, based on the current state of devices in the home and the user context.

16. A system for managing tasks for one or more of a plurality of electronic devices in a network, comprising:
a user interface module that enables a user to choose and executes tasks; and
a task manager that provides the user interface module access to tasks available in the network, and executes the tasks utilizing on one or more of devices in the network.

17. The system of claim 16 wherein the task manager provides access to tasks available in the network by:
determining the user's context in the network;
generating list of available tasks based at least on the user context;
providing task choices to the user interface module to provide to the user;
receiving user selection from the user interface module; and
dynamically updating the choices available to the user based on the user's input and the state of the devices, thereby effectively guiding the user input.

18. The system of claim 17 wherein the task manager dynamically updates said choices by, while the user provides input, dynamically updating the choices available to the user based on the user's input and the state of the devices, thereby effectively guiding the user input.

19. The system of claim 17 wherein the user interface module further allows the user to browse through the tasks possible in the network.

20. The system of claim 17 wherein the task manager further provides intelligent control of the devices in the network based on the user context and device state in the network.

21. The system of claim 17 wherein the task manager further includes interfaces for exploring tasks possible in the network.

22. The system of claim 17 wherein the task manager further provides task-related choices available for the user to compose a task request.

23. The system of claim 22 wherein the task manager further updates and filters the task related choices provided to the user, based on user input and the state of the devices in the home.

24. The system of claim 23 wherein the task manager further updates and filters the task related choices provided to the user, based on user input and the state of the devices in the home, as the user is framing a task request.

25. The system of claim 17 wherein the task manager further provides interfaces to execute a task by the devices in the network.

26. The system of claim 25 further including middleware functionalities for the task manager to appropriately access and control the devices needed to execute a task.

27. The system of claim 26 wherein the task manager further includes interfaces to store and communicate to the middleware layer information including user choices, user context and a device used by the user.

28. The system of claim 17 wherein the task manager further customizes and prioritizes task related information based on the user context and device states.

29. The system of claim 28 wherein the task manager further customizes and prioritizes task related information based on one or more of: user location, device used as a client, security policies applicable to the user, prior choices made by the user and prior tasks executed by the user.

30. The system of claim 17 wherein the task manager further dynamically updates the user interface module to notify the user of newly possible tasks and tasks no longer available, based on the current state of devices in the home and the user context.

31. The system of claim 17 wherein the task manager further determines state of the devices in the home network.
